(19) United States
(12) Patent Application Publication
(10) Pub. No.: US 2017/0069017 A1
(43) Pub. Date: Mar. 9, 2017

(54) Systems and Methods for Facilitating Transactions Between Consumers and Merchants

(71) Applicant: MASTERCARD INTERNATIONAL INCORPORATED, Purchase, NY (US)

(72) Inventor: Michael J. Friedman, Stamford, CT (US)

(21) Appl. No.: 14/844,489

(22) Filed: Sep. 3, 2015

(51) Int. Cl. G06Q 30/08

(52) U.S. Cl. CPC G06Q 30/08

(57) ABSTRACT

Systems and methods are provided for facilitating a transaction between a consumer and at least one merchant for one or more products. A purchase request is initially received, at a computing device, from a consumer. The purchase request includes an intent to purchase a product. At least one characteristic of the product to be purchased by the consumer is identified by the computing device, based on the intent in the purchase request. The at least one characteristic is then disseminated to multiple different merchants. When a bid is received back from at least one of the multiple different merchants, identifying a product relating to the intent in the consumer's purchase request, the bid is transmitted to the consumer. And, when the consumer selects the bid, a transaction request is generated and processed, via a payment network, for the product identified in the bid.

### FIELD

The present disclosure generally relates to systems and methods for facilitating transactions between consumers and merchants, for example, using a bidding process by the merchants.

### BACKGROUND

This section provides background information related to the present disclosure which is not necessarily prior art.

Purchases of products, e.g., goods and services, are often funded through transactions to payment accounts. In general, the transactions are coordinated through merchants (offering the products for purchase), acquirers associated with the merchants, one or more service providers (or payment network interchanges), and issuers of the payment accounts.

### DRAWINGS

The drawings described herein are for illustrative purposes only of selected embodiments and not all possible implementations, and are not intended to limit the scope of the present disclosure.

FIG. 1 is a block diagram of an exemplary system of the present disclosure suitable for use in facilitating purchase transactions between consumers and merchants, using a bidding process by merchants;

FIG. 2 is a block diagram of a computing device that may be used in the exemplary system of FIG. 1;

FIG. 3 is an exemplary method, suitable for use with the system of FIG. 1, for processing a purchase request from a consumer as part of facilitating a purchase transaction between the consumer and at least one merchant; and

FIGS. 4-6 illustrate example interfaces that can be used in connection with the system of FIG. 1 and/or the method of FIG. 3.

Corresponding reference numerals indicate corresponding parts throughout the several views of the drawings.

### DETAILED DESCRIPTION

Example embodiments will now be described more fully with reference to the accompanying drawings. The description and specific examples included herein are intended for purposes of illustration only and are not intended to limit the scope of the present disclosure.

Consumers often enter into transactions with merchants to purchase products, e.g., goods and services. However, it is often difficult for the consumers to identify merchants offering products satisfying the consumer's particular needs. The systems and methods described herein are generally directed toward intent-driven commerce and operate to process intent-based purchase requests from consumers, by facilitating bids from multiple merchants for products identified by the merchants as relating to, and potentially satisfying, the consumers' purchase requests based on one or more product characteristics derived from the consumers' intent. As such, the systems and methods provide an improved mechanism for connecting consumers, in search of products, to merchants offering such products (or offering, at the least, related products) for purchase.

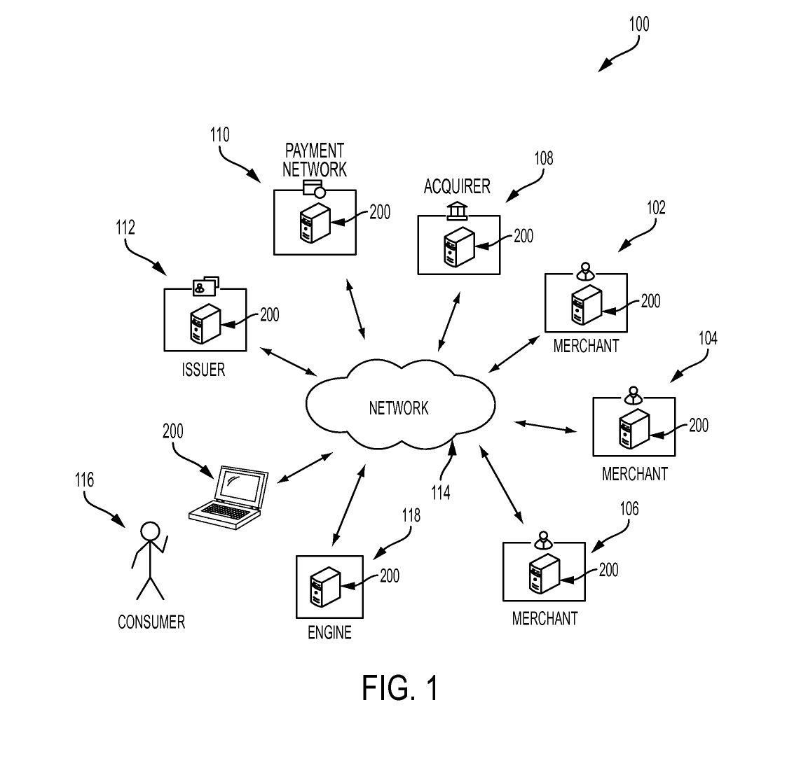

FIG. 1 illustrates an exemplary system 100 in which one or more aspects of the present disclosure may be implemented. Although components of the system 100 are presented in one arrangement, it should be appreciated that other exemplary embodiments may include the same or different components arranged otherwise, for example, depending on interactions and/or relationships between various components in the exemplary embodiments, processing of payment transactions in the exemplary embodiments, etc.

As shown in FIG. 1, the illustrated system 100 generally includes multiple merchants 102-106, an acquirer 108, a payment network 110, and an issuer 112, each coupled to network 114. The merchants 102-106 may include online merchants, having virtual locations on the Internet (e.g., websites accessible through the network 114, etc.), or through web-based applications, etc., to permit consumers (e.g., consumer 116) to initiate transactions for products offered by the merchants 102-106 for purchase, etc. In addition, one or more of the merchants 102-106 may also include at least one brick-and-mortar location.

The system 100 also includes an intent processing engine 118 coupled to the network 114 and configured, often by computer executable instructions, to process intent-based purchase requests from the consumer 116 (and from other consumers in the system 100), and further to facilitate bids from select ones of the merchants 102-106 for particular products identified by the merchants 102-106 as relating to the consumer's purchase request (and particularly to an intent expressed in the consumer's purchase request). Particular operations of the engine 118 will be described in more detail hereinafter.

The network 114 of the system 100 may include, without limitation, a wired and/or wireless network, a local area network (LAN), a wide area network (WAN) (e.g., the Internet, etc.), a mobile network, and/or another suitable public and/or private network capable of supporting communication among two or more of the illustrated components of the system 100, or any combination thereof. In one example, the network 114 includes multiple networks, where different ones of the multiple networks are accessible to different ones of the illustrated components in FIG. 1. For example, the network 114 may include a private payment transaction network made accessible by the payment network 110 to the acquirer 108 and the issuer 112, and separately, a network through which the merchants 102-106, the consumer 116, and the engine 118 communicate intent-based transactions (as will be described more hereinafter).

While only three merchants 102-106 and one consumer 116 are illustrated in FIG. 1, it should be appreciated that any number of merchants and/or consumers, as described herein, may be included in different embodiments Likewise, a different number of acquirers, payment networks, and/or issuers may be included. For example, different merchants may have one or more different acquirers, and different consumers may employ payment accounts issued by one or more different issuers. Further, while the engine 118 is shown as a stand-alone entity in FIG. 1, it should be appreciated that the engine 118 may be associated with (or incorporated into) another entity shown in FIG. 1, such as the payment network 110, or an entity not shown.

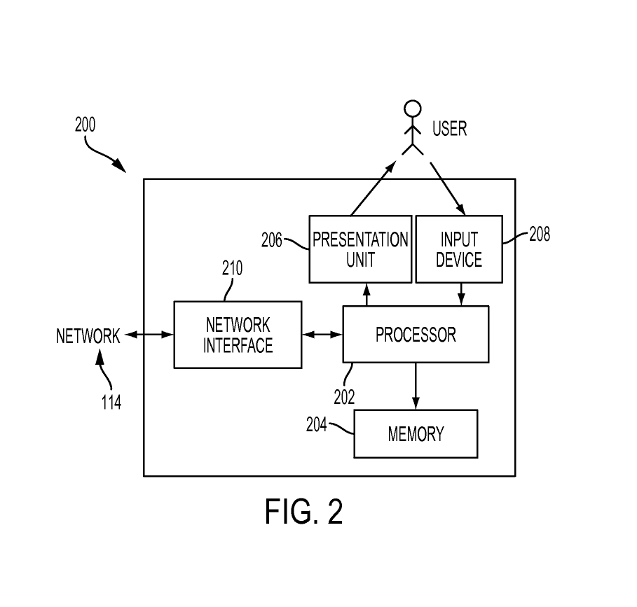

Each of the merchants 102-106, the acquirer 108, the payment network 110, the issuer 112, the consumer 116, and the engine 118 in the system 100 is associated with, or implemented in, one or more computing devices. For illustration, the system 100 is described herein with reference to exemplary computing device 200, illustrated in FIG. 2. Each of the merchants 102-106, the acquirer 108, the payment network 110, the issuer 112, the consumer 116, and the engine 118 is associated with such a computing device 200. However, the system 100 and its components should not be considered limited to the computing device 200, as different computing devices and/or arrangements of computing devices may be used. In addition, different components and/or arrangements of components may be used in other computing devices. Further, in various exemplary embodiments, the computing device 200 may include multiple computing devices located in close proximity, or distributed over a geographic region (such that each computing device 200 in the system 100 may represent multiple computing devices).

With reference to FIG. 2, the illustrated computing device 200 generally includes a processor 202, and a memory 204 that is coupled to the processor 202. The processor 202 may include, without limitation, one or more processing units (e.g., in a multi-core configuration, etc.), including a general purpose central processing unit (CPU), a microcontroller, a reduced instruction set computer (RISC) processor, an application specific integrated circuit (ASIC), a programmable logic circuit (PLC), a gate array, and/or any other circuit or processor capable of the functions described herein. The above examples are exemplary only, and are not intended to limit in any way the definition and/or meaning of processor.

The memory 204, as described herein, is one or more devices that enable information, such as executable instructions and/or other data, to be stored and retrieved. The memory 204 may include one or more computer-readable storage media, such as, without limitation, dynamic random access memory (DRAM), static random access memory (SRAM), read only memory (ROM), erasable programmable read only memory (EPROM), solid state devices, CD-ROMs, thumb drives, tapes, flash drives, hard disks, and/or any other type of volatile or nonvolatile physical or tangible computer-readable storage media. The memory 204 may be configured to store, without limitation, purchase requests, merchant bids, consumer responses to merchant bids, consumer profiles, merchant profiles, intent (or indicators of intent) to purchase products, characteristics, transaction data, and/or any other types of data suitable for use as described herein, etc.

Furthermore, in various embodiments, computer-executable instructions may be stored in the memory 204 for execution by the processor 202 to cause the processor 202 to perform one or more of the functions described herein, such that the memory 204 is a physical, tangible, and non-transitory computer-readable storage media. It should be appreciated that the memory 204 may include a variety of different memories, each implemented in one or more of the functions or processes described herein.

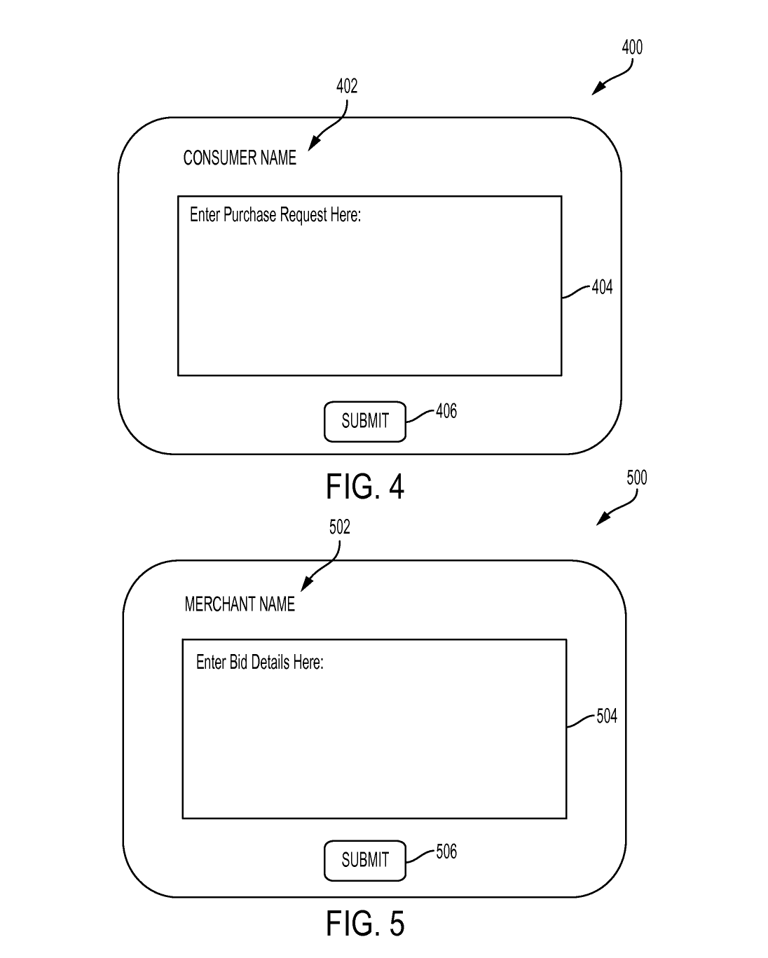

The illustrated computing device 200 also includes a presentation unit 206 that is coupled to the processor 202. The presentation unit 206 outputs, or presents, to a user (e.g., the consumer 116; individuals associated with one or more of the merchants 102-106, the acquirer 108, the payment network 110, the issuer 112, or engine 118 in the system 100; etc.) by, for example, displaying, audibilizing, and/or otherwise outputting information such as, but not limited to, information relating to bids, products, transaction data, and/or any other type of data. It should be further appreciated that, in some embodiments, the presentation unit 206 comprises a display device such that various interfaces (e.g., applications, webpages, etc.) may be displayed at computing device 200, and in particular at the display device, to display such information and data (see, e.g., interfaces 400-600 in FIGS. 4-6, etc.), etc. And in some examples, the computing device 200 may cause the interfaces to be displayed at a display device of another computing device, including, for example, a server hosting a website having multiple webpages, etc. With that said, presentation unit 206 may include, without limitation, a liquid crystal display (LCD), a light-emitting diode (LED) display, an organic LED (OLED) display, an “electronic ink” display, speakers, combinations thereof, etc. In some embodiments, presentation unit 206 includes multiple units.

The computing device 200 further includes an input device 208 that receives input from the user. The input device 208 is coupled to the processor 202 and may include, for example, a keyboard, a pointing device, a mouse, a stylus, a touch sensitive panel (e.g., a touch pad or a touch screen, etc.), another computing device, and/or an audio input device. Further, in some exemplary embodiments, a touch screen, such as that included in a tablet, a smartphone, or similar device, behaves as both a presentation unit and an input device. In at least one exemplary embodiment, a presentation unit and/or an input device are omitted from a computing device.

In addition, the computing device 200 is illustrated as coupled to network 114. In connection therewith, the illustrated computing device 200 includes a network interface 210 coupled to the processor 202 (and, in some embodiments, to the memory 204 as well), in order to couple to such network 114 and/or to other networks (e.g., the Internet, an intranet, a private or public LAN, WAN, mobile network, telecommunication networks, combinations thereof, or other suitable networks, etc. that are either part of the network 114, or separate therefrom). The network interface 210 may include, without limitation, a wired network adapter, a wireless network adapter, a mobile telecommunications adapter, or other device capable of communicating to one or more different networks, including the network 114. In some exemplary embodiments, the computing device 200 includes the processor 202 and one or more network interfaces incorporated into or with the processor 202.

By way of example (and without limitation), the exemplary computing device 200 may include one or more servers, workstations, personal computers, laptops, tablets, PDAs, telephones (e.g., cellular phones, smartphones, other phones, etc.), point of sale (POS) terminals, combinations thereof, etc., as appropriate.

With reference again to FIG. 1, generally, the consumer 116 registers with the engine 118, or with a service provider related to the engine 118 or in communication with the engine 118, when desired (e.g., as part of a subscription, etc.) to solicit bids from one or more of merchants 102-106 in connection with aspects of the present disclosure. As part of the registration, the consumer 116 may be granted access to a consumer application (via a consumer dashboard) for use in communicating with the engine 118. For example, the engine 118 may support a website or application (e.g., the consumer application, etc.) through which the consumer 116 can register and generate a user account. In so doing, the engine 118 obtains certain data from the consumer 116, and stores it as part of the user account (e.g., in a data structure associated with the engine 118, for example, in memory 204, etc.), including identity information for the consumer 116 such as, for example, name and address, payment account information and related payment preferences or specifications, delivery information for the consumer 116, consumer product preferences (e.g., size preferences, color preferences, style preferences, retailer preferences, etc.), consumer interests, hobbies, regular activities, social network data, payment history, purchase history, purchase methods and/or preferences, loyalty accounts/status, other payment information, etc. Some or all of the data provided is compiled, by the engine 118, into a consumer profile for the consumer 116 and stored with (or separate from) the user account. The data may be updated or modified by the consumer 116, as desired, by subsequently accessing the user account (e.g., by subsequently logging into the account, etc.). In addition, transaction history may be accessible to the consumer 116 through the user account, for example, to review prior transactions and receipts therefor, prior purchase requests, pending transactions, prior bids, prior accepted bids, etc.

Similarly, the merchants 102-106 register with the engine 118, or with a service provider related to the engine 118 or in communication with the engine 118, when desired (e.g., as part of a subscription, etc.) in order to provide bids to consumers in connection with aspects of the present disclosure. As part of the registration, the merchants 102-106 may be granted access to a merchant application (via a merchant dashboard) for use in communicating with the engine 118. For example, the engine 118 may support a website or application (e.g., the merchant application, etc.) through which each of merchants 102-106 can register and generate a merchant account. In so doing, the engine 118 obtains certain data from the merchants 102-106, and stores it as part of the merchant accounts (e.g., in the data structure associated with the engine 118, for example, in memory 204, etc.), including identity information for the merchants 102-106, such as name, merchant category codes, other data indicative of the types of products and/or brands offered for purchase by the merchants 102-106, general (or specific) descriptions for products offered for purchase by the merchants 102-106, payment account information, shipping information for the merchants 102-106, locations for the merchants 102-106, hours of operation for the merchants 102-106, shipping options available through the merchants 102-106, terms and conditions associated with purchases at the merchants 102-16, return policies for the merchants 102-106, etc. Some or all of the data provided is compiled, by the engine 118, into a merchant profile for the corresponding merchants 102-106, and stored with (or separate from) the merchant account. The data may be updated or modified by the merchants 102-106, as desired, by subsequently accessing the accounts (e.g., by subsequently logging into the accounts, etc.). In addition, transaction history may be accessible to the merchants 102-106 through the accounts, for example, to review prior transactions, pending transactions, prior bids provided by the merchants 102-106, prior bids provided by the merchants 102-106 and accepted, etc.

When the consumer 116 desires to initiate a purchase of products, the consumer 116 submits a purchase request expressing an intent to purchase, via the consumer application made available to the consumer 116, at computing device 200, by the intent processing engine 118, or by another entity. The request is then sent to the engine 118, via the consumer application, where the engine 118 analyzes the request to identify characteristics from the consumer's intent, i.e., characteristics of a product identified in the request (as described below, for example) and then disseminates the characteristics, as appropriate, to select ones of the merchants 102-106. In turn, the merchants 102-106 receive the request, via the merchant application made available to each of the merchants 102-106 at their corresponding computing devices 200 by the engine 118, or by another entity. The merchants 102-106 can then respond with desired bids, for products indicated by the characteristics, through the merchant application. The engine 118 reviews the bids and presents them, as appropriate, to the consumer 116 for consideration. Upon selection of a bid (or multiple bids) for the merchants 102-106, the consumer 116 notifies the engine 118 through the consumer application.

In connection with a selected bid by the consumer 116, and the products identified therein, the engine 118 communicates with the merchant associated with the bid (merchant 102 in the following description), the acquirer 108, the payment network 110, and the issuer 112 to generate a contract, in some embodiments, and authorize and clear a purchase transaction for the product (e.g., using the MasterCard® interchange, etc.). For example, the engine 118 communicates payment account information for the consumer 116 (from the consumer's user account or as separately provided in the request or when selecting a bid), via the acquirer 108 and through the payment network 110, to the issuer 112 for authorization for the purchase transaction. If the issuer 112 accepts the purchase transaction, an authorization response is provided back through the payment network 110 (and the acquirer 108) to the engine 118. Upon authorization, the engine 118 notifies the merchant 102 and the transaction generally is completed (between the merchant 102 and the consumer 116). The balance (or credit) of the payment account used by the consumer 116 in the purchase transaction is altered (e.g., reduced, etc.) by the amount of the purchase transaction, and the transaction is posted to the consumer's payment account. Similarly, the balance of the payment account used by the merchant 102 is altered (e.g., increased, etc.) by the amount of the purchase transaction. The engine 118 further generates, and stores in memory (e.g., memory 204, etc.) a contract record or receipt for the transaction, which may be viewed later, for example, through the consumer's or merchant's account. The purchase transaction is later settled and cleared by and between the acquirer 108 and the issuer 112, directly or via the payment network 110. Other transactions in the system 100, for example, involving the other merchants 104, 106, etc. are processed in a similar manner.

Transaction data is generated, collected, and stored as part of the above interactions among the merchant 102, the acquirer 108, the payment network 110, the issuer 112, and the engine 118. The transaction data represents at least a plurality of transactions, e.g., completed transactions, attempted transactions, etc. The transaction data, in this exemplary embodiment, is stored by (or at) at least one of: the payment network 110 and the engine 118, in a data structure associated therewith, depending on the particular embodiment, etc. Additionally, or alternatively, the merchant 102, the acquirer 108, and/or the issuer 112 may store the transaction data, or part thereof, in memory 204. The transaction data may include, for example, payment account numbers, amounts of the transactions, merchant IDs, merchant category codes, dates/times of the transactions, product identifiers, etc. It should be appreciated that more or less information related to processing, approving, and/or declining transactions may be included in transaction data and stored within the system 100, at the acquirer 108, the payment network 110, the issuer 112, and/or the engine 118.

In various exemplary embodiments, consumers involved in the different transactions herein agree to legal terms associated with their payment accounts, for example, during enrollment in their accounts, etc. In so doing, the consumers may agree, for example, to allow merchants, issuers of the payment accounts, payment networks, etc. to use data collected during enrollment and/or collected in connection with processing the transactions, subsequently for one or more of the different purposes described herein.

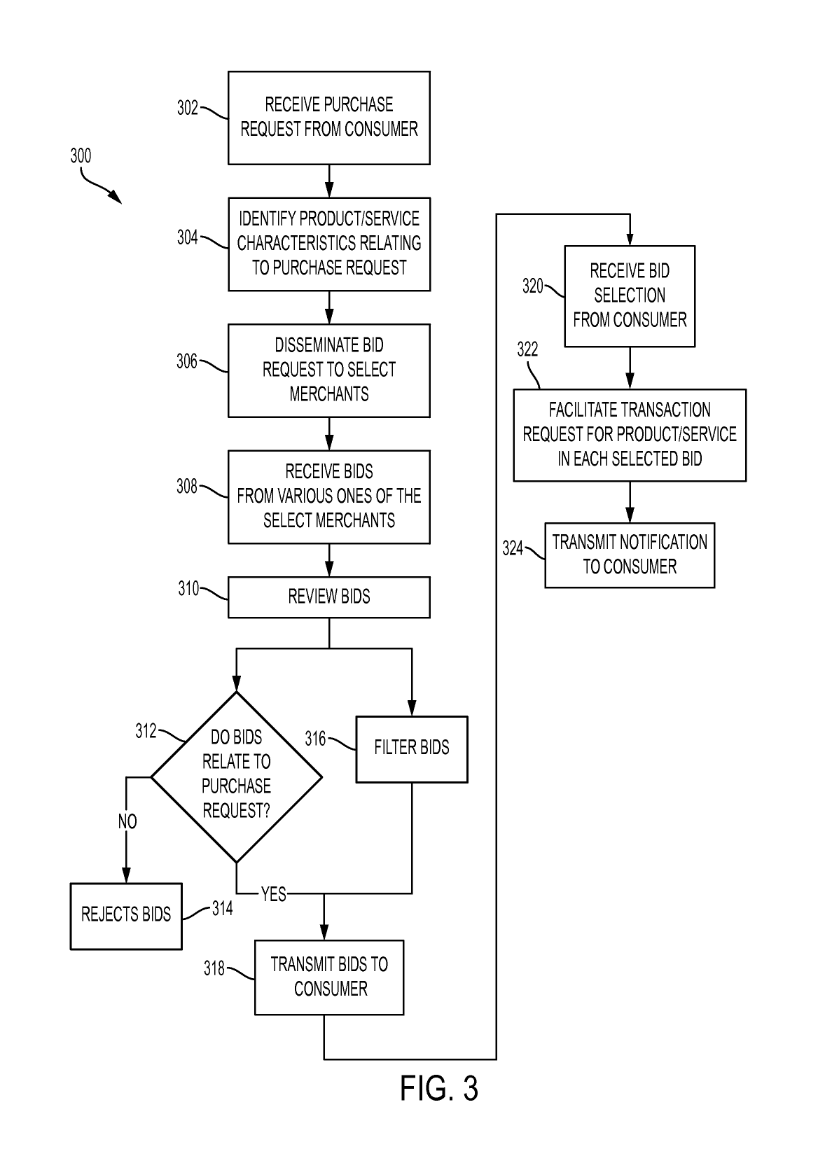

FIG. 3 illustrates exemplary method 300 that can be used in connection with the system 100 (or in connection with other systems herein) for use in processing a request from the consumer 116 to purchase a product. The exemplary method 300 is described as implemented in the engine 118 of the system 100, with further reference to the merchants 102-106. However, the method 300 could be implemented in one or more other entities, in other embodiments (e.g., in the payment network 110 of the system 100, etc.). Further, for purposes of illustration, the exemplary method 300 is described herein with reference to the computing device 200. Just as the method 300, and other methods herein, should not be understood to be limited to the exemplary system 100, or the exemplary computing device 200, the system 100 (and other systems) and the computing device 200 (and other computing devices) herein should not be understood to be limited to the exemplary method 300.

In the method 300, the engine 118 initially receives, at 302, a purchase request from the consumer 116, which includes an intent, by the consumer 116, to purchase a product (where, in some examples, the intent includes added details providing further context to the intent). The intent may have any form and may generally indicate, for example, various qualities of the product to be purchased that are important to, or even required by, the consumer 116 in connection with the request (e.g., a need, a timing, a quality, a price or price limit, etc.), general preferences of the consumer 116 (e.g., size, color, brand, favorites, etc.), contextual requirements (e.g., weather, a timing, a day, a location, etc.), etc. In addition, the intent may be provided directly by the consumer 116 (e.g., via a field in an application interface or a website interface associated with the engine 118, etc.). Or, in at least one embodiment, the intent may be selected from predefined intents or characteristics provided by the engine 118 (e.g., at a series of radio buttons or from multiple drop-down menus in an application/website interface supported by the engine 118, etc.). Example intents forming a purchase request may include: “an outfit for a dinner party tonight” qualitied by a favorite color and a desired size, “travel to New York City by noon” qualitied by various travel mode preferences, “birthday party entertainment” qualified by a time/date for the birthday party, etc.

FIG. 4 illustrates an example interface 400, provided through the consumer application, for example, that may be used by the consumer 116, at computing device 200, to generate and submit the purchase request. The interface 400 generally includes an indication 402 of the consumer 116, as retrieved from the consumer's user account (e.g., at login, etc.). The interface 400 also generally includes a field 404 in which the consumer 116 can enter his/her intent in his/her own words (so as to not only provide the intent but also additional context for the intent), and a submit button 406 for transmitting the purchase request to the engine 118 (e.g., to the engine's computing device 200, etc.), via network 114.

From the purchase request, the engine 118 identifies characteristics (e.g., at least one characteristic, etc.) of the product to be purchased based on the intent in the request, at 304. As will be seen, the characteristics help, in subsequent operations, to determine what products to offer the consumer 116, in response to the request. The characteristics may include a product description, or a quality or feature related to the product or to the merchant that generally matches, or satisfies, the intent. Or, the characteristic may include a particular merchant category code (MCC) that relates to the intent. For example, for a purchase request in which the intent is “an outfit for a dinner party tonight,” the engine 118 may identify characteristics, such as, for example, formal clothing derived from “dinner party,” within 15 miles derived from “tonight,” etc., which may then cause the engine 118 to identify merchants having MCCs for clothing rental and/or men's and women's formal clothing stores, with the merchants subsequently filtered by the required location, etc.

The intent included in the purchase request, or in forming the purchase request, typically does not identify a particular product (i.e., a brand X white dress shirt, size 16-34) that the consumer 116 intends to purchase (although, in some embodiments it may include some detail or context). Instead, in the method 300, the intent includes a general description of the product, an event or a circumstance related to the product, or the reason, or motivation, for purchasing the product or for which the resulting product is needed.

In addition, in identifying characteristics relating to the intent, the engine 118 operates, in a sense, to interpret the intent and identify best guess, most suitable, etc., options for the consumer 116. For example, the engine 118 would likely find different merchants for the following similar intents: “I need an outfit for the opera tonight” as compared to “I need an outfit for a concert tonight.” As such, to improve accuracy of the characteristics, the engine 118 may use historical data to help evaluate the consumer's intent and identify the characteristics. For example, the engine 118 may use historical data relating to prior purchases, accepted bids, etc., for the consumer 116, or historical data relating to prior purchases, accepted bids, etc., for other consumers providing purchase requests with similar intents, etc. Further, the engine 118 may identify predefined characteristics for the consumer's intent based on particular keywords included in the purchase request. For example, for a purchase request using terms such as outfit, clothes, wear, and variations thereof, the engine 118 may generically identify the request with a clothing characteristic, but when further provided with keywords, such as, for example, game, opera, concert, dinner, fishing, etc., the engine 118 is provided a specific direction to the type of clothing merchants, to which to disseminate the clothing characteristic of the purchase request.

Various different operations can be used to interpret the intent and identify best guess, most suitable, etc., options for the consumer 116. For example, and without limitation, keyword matching may be used based on free-form input provided from the consumer 116 in the request. It is then contemplated that, over time, machine artificial intelligence can be used to provide a more free-form, intent-entry experience for the consumer 116 in the request, which can lead to more accurate keyword use/searching.

After identifying the characteristics relating to the intent of the purchase request, the engine 118 disseminates (e.g., transmits, etc.) a bid request to select merchants, at 306, providing the identified characteristics, so that the merchants 102-106 can determine what, if any, of their products may satisfy the consumer's intent (and if they want to submit a corresponding bid). The bid request may be sent directly to each of the select merchants 102-106 (e.g., to sale associates associated with the merchants 102-106, etc.). Or, the bid request may be posted, for example, to a message board, or other site, etc., provided by the engine 118, or by another entity, and available to, or accessible by, the merchants 102-106. In either case, the merchants 102-106 are then able to view the identified characteristics associated with the bid request, and determine whether or not to respond.

The select merchants 102-106 are identified, or selected, by the engine 118 from a listing of multiple available merchants maintained in the data structure associated with the engine 118 (e.g., associated with the memory 204 of the engine's computing device 200, etc.). The listing may include all merchants that are registered with the engine 118, as described in connection with the system 100, or it may include merchants that are affiliated with, or use the services of, another entity such as, for example, the payment network 110 in connection with processing purchase transactions for the merchants, etc. In addition, in the illustrated method 300, the select merchants 102-106 offer products relating to the characteristics of the purchase request identified by the engine 118. As such, the selection (or qualification) of merchants 102-106 is often done by the engine 118 based on product descriptions provided by the merchants during registration with the engine 118 or based on MCCs for the merchants 102-106, or other details for the merchants 102-106, for example, provided in their merchant profiles. In other embodiments, however, all available merchants may be included in the selection, without any filtering or limitation. The merchants 102-106 may then decide, on their own initiative, if they have any products that match or satisfy the consumer's intent in the bid request.

In response to the bid request from the engine 118, the merchants 102-106, in this exemplary embodiment, view the characteristics of the consumer's intent that align against preset preferences provided, for example, by the consumer 116 (e.g., via the consumer's profile, etc.). The data may be available to the merchants 102-106, for example, through a merchant dashboard, a dedicated terminal (e.g., computing device 200, etc.), etc. The merchants 102-106 further, in some embodiments, perform certain analysis to determine one or more products consistent with the characteristics (and/or intent) of the consumer 116 as provided from the engine 118. Because the characteristics are not delivered from the engine 118 as directed to a particular product, the merchants 102-106 perform analysis (e.g., manually, automatically via a rules engine or through artificial intelligence, etc.), not unlike the analysis performed by the engine 118 to identify a product, or multiple products, and/or merchants to include in the bid. For example, the merchants 102-106 may interpret the intent and/or characteristics to identify best guess, most suitable, etc. options for the consumer 116. Once identified, the merchants 102-106 compile bids, if products consistent with the request are located. Ultimately, one or more of the merchants 102-106 submits a bid to the engine 118.

With continued reference to FIG. 3, the engine 118 then receives bids from various ones of the select merchants 102-106, at 308, for one or more particular products offered by the merchants 102-106 for purchase that generally satisfy the characteristics identified in the bid request. The bids from the merchants 102-106 can include any desired data relating to the merchants 102-106 and the particular products offered. For example, the bids may include an identification of the merchant by name and address, a description of the particular products offered, prices of the particular products, delivery terms for the particular products, etc.

FIG. 5 illustrates an example interface 500, provided through the merchant application, for example, that may be used by one of the merchants 102-106, at computing device 200, to generate and submit a bid in response to the bid request (and the consumer's purchase request). The interface 500 generally includes an indication 502 of the merchant submitting the bid, as retrieved from the merchant's user account (e.g., at login, etc.), and a field 504 identifying various details of the merchant's bid including, for example, a product name, a product price, and a product description. The interface 500 also generally includes a submit button 506 for transmitting the bid to the engine 118 (e.g., to the engine's computing device 200, etc.), via network 114.

Next in the method 300, and prior to transmitting the bids to the consumer 116, the engine 118 reviews the bids, at 310.

As part of the review, the engine 118 initially determines, at 312, whether or not the bids are in fact related to the intent (or specifically, the identified characteristics) of the consumer's purchase request. In essence, the engine 118 performs a quality control check on the bids. Bids that relate to the intent of the consumer's purchase request are further processed as described next, while bids that do not relate to the intent of the consumer's purchase request are rejected at 314. As an example, for the above purchase request in which the intent provided by the consumer 116 is “an outfit for a dinner party tonight,” the engine 118 may discard or reject bids from merchants directed to automobile purchases or long-term car rentals, or bids from merchants directed to products available in the future (and not tonight), or bids from merchants directed to sports clothing or outdoor equipment.

Also as part of the review, the engine 118 filters the bids, at 316. Such filtering may be done based on any desired data, or characteristics, including temporal data, consumer preferences provided in his/her user account, etc. For example, for the above purchase request, again in which the intent provided by the consumer 116 is “an outfit for a dinner party tonight”, the engine 118 may identify a weather forecast for tonight at the location of the consumer 116 (as determined from the consumer's user account or as provided in the purchase request) and filter bids for clothing that are inconsistent with the forecasted weather. Similarly in this example, the engine 118 may filter the bids based on a size, color, style, etc., preferences indicated by the consumer 116 in his/her user account or provided as supplemental or contextual data in the purchase request (e.g., directly, via radio buttons, via drop-down menus, etc.).

With further reference to FIG. 3, once the review is complete, the engine 118 transmits the received bids to the consumer 116 at 318. For example, the engine 118 may send an email notification (broadly, a bid notification) to the consumer 116 indicating that bids have been received in connection with the consumer's purchase request. The email notification may then identify the bids and the content thereof, or the email notification may instead include a link to a webpage interface provided by the engine 118 (e.g., as part of the consumer application, etc.) where the consumer 116 can view the bids (e.g., via a login process, etc.).

At 320, the engine 118 then receives a selection of one or more of the transmitted bids from the consumer 116. In response, the engine 118 transmits a notification to each of the merchants 102-106 associated with the selected bids, indicating that their bids were accepted. In some aspects of the method 300, the response from the consumer 116 may also include feedback relating to one or more of the bids. The engine 118 may use the feedback to update data in the user account, or for use in the review operation in connection with future purchase requests. In addition, the engine 118 may transmit the feedback to the particular merchants affected by the feedback, for example, for use in future transactions.

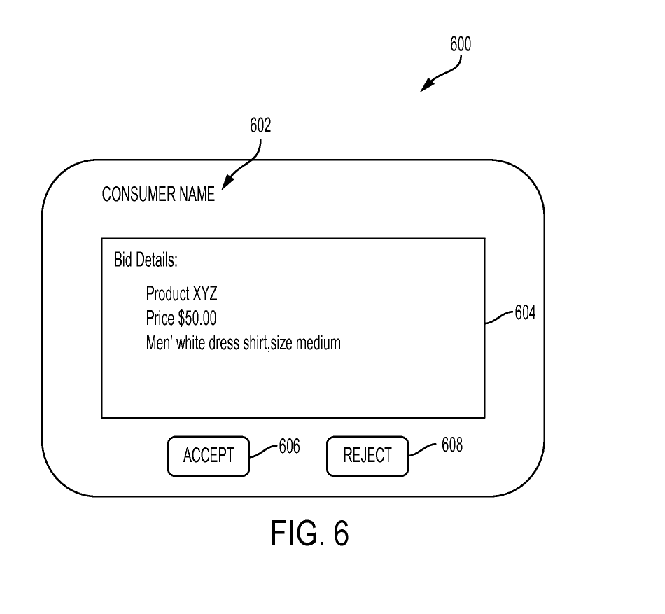

FIG. 6 illustrates an example interface 600, provided through the consumer application, for example, that may be used by the engine 118 to transmit a bid to the consumer 116 and for the consumer 116 to accept or reject the bid (at computing device 200). The interface 600 again generally includes an indication 602 of the consumer 116. The interface 600 also generally includes a field 604 in which details of the bid are provided, and buttons 606, 608 by which the consumer 116 can accept or reject the bid and submit the response to the engine 118 (e.g., to the engine's computing device 200, etc.), via network 114.

Broadly, for example, the merchants 102-106 offer products for purchase, traditionally, in some instances, based on the products offered by their suppliers. The merchants 102-106, through the systems and methods herein, may be permitted to understand the consumer's intent, which may be more instructive than prior purchase history. For example, if a hardware merchant offers black and green widgets for purchase, but the purchase requests from consumers include four times more requests for blue widgets than green widgets, the merchant (and other merchants) may become educated about what the consumers actually want. More particularly, consumers traditionally can only select among the options that are given (i.e., black and green widgets), and have no mechanism (outside of a separate survey) to deliver their real intent, or desire, to purchase something else (i.e., blue widgets). The merchants may further understand the purchase requests herein as providing a direction (or at least an invitation), to the merchants, to offer blue widgets for purchase (along with the black widgets), instead of green widgets.

Thus, the systems and methods herein, by taking purchase requests in the consumers' own words or by user selected descriptions, provide a further insight into the consumer 116, previously unavailable. The insight may be gained by the merchants' review of the purchase request, and/or the insight may be the subject or conclusion of one or more reports prepared by the engine 118 and delivered to one or more of merchants 102-106. The reports may include, for example, statistics related to frequency of intents expressed by the consumer, the particular intents/characteristics themselves, statistics related to frequency of certain merchants being selected to offer a bid, statistics related to frequency of merchant bids being selected, statistics related to competing merchants, the intent/characteristics and related statistics of other consumers (e.g., generally, or based on similar age, location, gender, interests, etc.), and/or many other data summaries and/or descriptions available in view of the above methods and systems. Additionally, or alternatively, the reports may be provided as a statement to the consumer or merchant account, whereby the consumer or merchant may be able to assess past purchases, performance, budgeting, future purchases/stock, etc. Furthermore, in some embodiments, the merchant and/or consumer is provided options to bids, merchant responses to bids, transactions (e.g., completed, shipped, and/or shipping details, etc.), or other details related to the consumers' attempt to purchase a product, or the merchant's response to that attempt.

With continued reference again to FIG. 3, at 322, the engine 118 facilitates a transaction request for the product(s) included in each of the consumer's selected bids (based on the data included in the bids). As part of the transaction request, in some implementations of the method 300, the engine 118 may also facilitate authorization and clearance of the transaction request between the merchant associated with each selected bid and the consumer 116 (generally, as previously described in connection with the system 100). At about the same time, or earlier or later, the engine 118 further transmits a notification to the consumer 116, at 324, indicating that the transaction request has been generated and is being (or has been) processed, and providing a receipt for the transaction.

The merchant completes the transaction by delivering the product to the consumer 116, as appropriate.

In various embodiments, the intent processing engine 118 of the system 100 may be associated with a web-based application through which it performs various operations described herein. For example, via the application, the engine 118 may connect stated consumer intent to participating merchants, conduct analysis on stated consumer intent including aggregation of same or similar intent from multiple consumers, select eligible merchants from which to solicit bids or offers meeting the consumer's stated intent, analyze and distribute bids to consumers, authorize payment from consumers upon acceptance of a bid, convey acceptance of a bid to the selected merchant, create a contractual record of the transaction, clear the payment, and track, monitor and/or report on consumer and merchant activity.

In various embodiments, the consumer 116, via the consumer application, can perform various operations described herein. For example, via the consumer application, the consumer 116 may input his/her intent, receive bids or offers to fulfill against the consumer's stated intent, complete the purchase of and/or secure said bids or offers for products, provide feedback on offers/products/services, receive and store digital receipts, track and/or monitor historical requests and/or purchases, and manage payment and order information, preferences and account settings.

In various embodiments, the merchants 102-106, via the merchant application, can perform various operations described herein. For example, via the merchant application, the merchants 102-106 may view consumers' intents that align against preset preferences, analyze stated consumer intent to determine bid parameters, enable the delivery of bids or offers against a consumer's stated intent, display confirmation of accepted offers/bids, and track and/or monitor history of offers and bids made through the application.

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of (a) receiving a purchase request from a consumer, where the purchase request includes an intent to purchase a product; (b) identifying at least one characteristic of the product to be purchased by the consumer based on the intent in the purchase request; (c) disseminating the at least one characteristic to multiple different merchants; (d) transmitting a bid notification to the consumer, when a bid is received from at least one of the multiple different merchants identifying a product relating to the intent in the consumer's purchase request; and (e) causing a transaction request to be processed, via a payment network, for the product identified in the bid, when the consumer selects the bid.

With that said, exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed. In addition, as used herein, the term “and/or” includes any and all combinations of one or more of the associated listed items.

In addition, as used herein, the term product may include a good and/or a service.

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for facilitating a transaction between a consumer and at least one merchant for one or more products, the computer-implemented method comprising:
receiving a purchase request from a consumer, the purchase request including an intent to purchase a product;
identifying, by a computing device, at least one characteristic of the product to be purchased by the consumer based on the intent in the purchase request;
disseminating the at least one characteristic to multiple different merchants;
transmitting a bid notification to the consumer, when a bid is received from at least one of the multiple different merchants identifying a product relating to the intent in the consumer's purchase request; and
causing a transaction request to be processed, via a payment network, for the product identified in the bid, when the consumer selects the bid.

2. The computer-implemented method of claim 1, further comprising receiving at least two bids from the at least one of the multiple different merchants.

3. The computer-implemented method of claim 2, wherein the bid notification includes data relating to the at least two bids.

4. The computer-implemented method of claim 3, wherein the at least two bids are for at least two different potential products relating to the at least one characteristic.

5. The computer-implemented method of claim 2, wherein disseminating the at least one characteristic to the multiple different merchants includes transmitting the at least one characteristic directly to each of the multiple different merchants.

6. The computer-implemented method of claim 2, wherein disseminating the at least one characteristic includes generating a post, including the at least one characteristic.

7. The computer-implemented method of claim 2, further comprising selecting the multiple different merchants from multiple available merchants in a data structure associated with the computing device, based on the identified at least one characteristic of the product.

8. The computer-implemented method of claim 7, wherein selecting the multiple different merchants includes selecting the multiple different merchants based on their merchant category code (MCC), where the MCC of each of the selected merchants generally relates to the intent included in the purchase request and/or the identified at least one characteristic.

9. The computer-implemented method of claim 1, wherein causing the transaction request to be processed includes authorizing and clearing the transaction request.

10. The computer-implemented method of claim 1, wherein the intent of the purchase request includes a temporal indicator; and
wherein the at least one characteristic is identified, at last in part, based on the temporal indicator.

11. A system for facilitating a transaction between a consumer and at least one merchant for one or more products, the system comprising:
a memory comprising data relating to multiple different merchants; and
at least one processor coupled to the memory, the at least one processor configured to:
identify at least one characteristic of a potential product to be purchased by a consumer, based on an intent provided by the consumer in a purchase request transmitted to the at least one processor by the consumer;
disseminate the at least one characteristic to merchants selected from the multiple different merchants in the memory;
transmit a bid notification to the consumer, when a bid is received from at least one of the select merchants identifying a product for offer to the consumer; and
causing a transaction request to be generated for the product identified in the bid, when the consumer selects the bid.

12. The system of claim 11, wherein the memory further comprises a user account for the consumer; and
wherein, when a bid is received from at least one of the select merchants identifying a product for offer to the consumer, the at least one processor is further configured to filter the bid based on at least one preference included in the consumer's user account.

13. The system of claim 11, wherein the at least one processor is configured to select the merchants from the multiple different merchants in the memory based on the identified at least one characteristic of the potential product.

14. The system of claim 11, wherein the at least one processor is configured to select the merchants from the multiple different merchants in the memory based on their merchant category code (MCC), where the MCC of each of the selected merchants generally relates to the intent included in the purchase request and/or the identified at least one characteristic.

15. A non-transitory computer readable storage media including executable instructions which, when executed by at least one processor, cause the at least one processor to:
identify at least one characteristic of a potential product to be purchased by a consumer, based on an intent provided by the consumer in a purchase request transmitted to the at least one processor by the consumer;
disseminate the at least one characteristic to multiple different merchants;
transmit a bid notification to the consumer, when a bid is received from at least one of the multiple different merchants identifying a product for offer to the consumer; and
causing a transaction request to be generated for the product identified in the bid, when the consumer selects the bid.

16. The non-transitory computer readable storage media of claim 15, wherein the executable instructions, when executed by the at least one processor, further cause the at least one processor to select the multiple different merchants from available merchants in a data structure, based on the identified at least one characteristic of the product.

17. The non-transitory computer readable storage media of claim 15, wherein the executable instructions, when executed by the at least one processor, further cause the at least one processor to select the multiple different merchants from available merchants based on their merchant category code (MCC), where the MCC of each of the selected merchants generally relates to the intent included in the purchase request and/or the identified at least one characteristic.

18. The non-transitory computer readable storage media of claim 15, wherein the executable instructions, when executed by the at least one processor, further cause the at least one processor to receive the purchase request from the consumer.

19. The non-transitory computer readable storage media of claim 15, wherein the executable instructions, when executed by the at least one processor, further cause the at least one processor to filter the bid, when the bid is received from the at least one of the multiple different merchants, based on at least one preference included in a user account associated with the consumer.

20. The non-transitory computer readable storage media of claim 15, wherein the executable instructions, when executed by the at least one processor, further cause the at least one processor to authorize and clear the transaction request.
